(19) United States
(12) Patent Application Publication
(10) Pub. No.: US 2015/0042525 A1
(43) Pub. Date: Feb. 12, 2015

(54) ANTENNA DEVICE AND WIRELESS COMMUNICATION TERMINAL

(71) Applicants: NEC CASIO MOBILE COMMUNICATIONS, LTD., Kawasaki-shi, Kangawa (JP); NTT DOCOMO, INC., Chiyoda-ku, Tokyo (JP)

(72) Inventors: Takahiro Yoshida, Kanagawa (JP); Masanori Sakurai, Kanagawa (JP); Shinichiro Kitano, Kanagawa (JP); Daisuke Kurita, Tokyo (JP); Takashi Ueda, Tokyo (JP)

(73) Assignees: NTT DOCOMO, INC., Tokyo (JP); NEC CASIO MOBILE COMMUNICATIONS, LTD., Kanagawa (JP)

(21) Appl. No.: 14/384,736

(22) PCT Filed: Mar. 8, 2013
(86) PCT No.: PCT/JP2013/001527

§ 371 Date: Sep. 12, 2014

(30) Foreign Application Priority Data
Mar. 15, 2012 (JP) 2012-058957

(51) Int. Cl. H01Q 9/04

(52) U.S. Cl. CPC H01Q 9/0442; H01Q 9/0414
USPC 343/745

(57) ABSTRACT

An antenna device (10) includes a first antenna pattern (100), a second antenna pattern (200), and a frequency characteristic adjustment unit (400. The first antenna pattern (100) includes a feeding point (14). The second antenna pattern (200) is fed from the feeding point (14) similarly to the first antenna pattern (100). The frequency characteristic adjustment unit (400) is connected to the feeding point (14). The frequency characteristic adjustment unit (400) changes a frequency characteristic of at least one of the first antenna pattern (100) and the second antenna pattern (200).

### TECHNICAL FIELD

The present invention relates to an antenna device, which copes with a plurality of frequency bands, and a wireless communication terminal.

### BACKGROUND ART

Various characteristics are required for an antenna device which is used for wireless communication. One of the characteristics required for the antenna device is a variable (that is, tunable) resonance frequency. Patent Document 1 discloses an antenna which changes a resonance frequency of the antenna by connecting an open end of an inverted F-type antenna to the ground through a varicap diode.

In addition, Patent Document 2 discloses an antenna in which variable capacity elements are respectively provided in two wave reception elements which cope with frequency bands which are different from each other. The two wave reception elements are provided to cope with frequency bands (a UHF group of 470 MHz to 770 MHz) of a terrestrial digital television broadcast in Japan.

### RELATED DOCUMENT

### Patent Document

[Patent Document 1] Japanese Unexamined Patent Publication NO. 2009-296250
[Patent Document 2] Japanese Unexamined Patent Publication NO. 2010-41455

### DISCLOSURE OF THE INVENTION

In recent years, it has been required to cause a wireless communication terminal to cope with multiple bands. Thus, it is necessary to cause an antenna device which is embedded in the wireless communication terminal to cope with the multiple bands. On the other hand, the wireless communication terminal is required to be downsized. However, if the antenna device is caused to cope with the multiple bands, the antenna device becomes large.

An object of the invention is to provide an antenna device and a wireless communication terminal which are capable of coping with multiple bands and which are suppressed from being enlarged.

According to the present invention, there is provided an antenna device including: a first antenna pattern that has a feeding point; a second antenna pattern that is fed from a point which is the same as the feeding point; and a frequency characteristic adjustment section that is connected to the feeding point, and that is configured to change a frequency characteristic of at least one of the first antenna pattern and the second antenna pattern.

According to the present invention, there is provided an antenna device including: a first antenna pattern that has a feeding point; a second antenna pattern that is fed from a point which is the same as the feeding point; a first frequency characteristic adjustment section that is connected to the first antenna pattern, and that is configured to change a frequency characteristic of the first antenna pattern; and a second frequency characteristic adjustment section that is connected to the second antenna pattern, and that is configured to change a frequency characteristic of the second antenna pattern.

According to the present invention, there is provided a wireless communication terminal including: a first antenna pattern that has a feeding point; a second antenna pattern that is fed from a point which is the same as the feeding point; a frequency characteristic adjustment section that is connected to the feeding point, and that is configured to change a frequency characteristic of at least one of the first antenna pattern and the second antenna pattern; an oscillation signal generation unit that converts a signal, to be output to an outside, into an oscillation signal, which has a predetermined frequency, and supplies the oscillation signal to the feeding point; and a control unit that controls the frequency characteristic adjustment section according to a value of the predetermined frequency.

According to the present invention, there is provided a wireless communication terminal including: a first antenna pattern that has a feeding point; a second antenna pattern that is fed from a point which is the same as the feeding point; a first frequency characteristic adjustment section that is connected to the first antenna pattern, and that is configured to change a frequency characteristic of the first antenna pattern; a second frequency characteristic adjustment section that is connected to the second antenna pattern, and that is configured to change a frequency characteristic of the second antenna pattern; an oscillation signal generation unit that converts a signal, to be output to the outside, into an oscillation signal, which has a predetermined frequency, and supplies the oscillation signal to the feeding point; and a control unit that controls at least one of the first frequency characteristic adjustment section and the second frequency characteristic adjustment section according to a value of the predetermined frequency.

According to the present invention, it is possible to cause an antenna device to cope with multiple bands and it is possible to suppress the antenna device from being enlarged.

### BRIEF DESCRIPTION OF THE DRAWINGS

The above-described object, the other objects, features, and advantages will be apparent based on preferable embodiments, which will be described below, and the accompanying drawings below.

FIG. 1 is a planer view illustrating the configuration of an antenna device according to a first embodiment.

FIG. 2 is a perspective view illustrating the antenna device shown in FIG. 1.

FIG. 3 is a circuit diagram illustrating a frequency characteristic adjustment unit.

FIG. 4 is a Smith chart illustrating an antenna device according to a comparison example.

FIG. 5 is a Smith chart illustrating the antenna device.

FIG. 6 is a diagram illustrating the configuration of an antenna device according to a second embodiment.

FIG. 7 is a diagram illustrating the configurations of a first frequency characteristic adjustment unit and a second frequency characteristic adjustment unit.

FIG. 8 is a diagram illustrating an example of a first circuit and a third circuit in detail.

FIG. 9 is a diagram illustrating an example of a second circuit and a fourth circuit in detail.

FIG. 10 is a diagram illustrating a connection state of the first frequency characteristic adjustment unit and the second frequency characteristic adjustment unit when the antenna device corresponds to 700 MHz.

FIG. 11 is a diagram illustrating the connection state of the first frequency characteristic adjustment unit and the second frequency characteristic adjustment unit when the antenna device corresponds to 800 MHz.

FIG. 12 is a diagram illustrating the connection state of the first frequency characteristic adjustment unit and the second frequency characteristic adjustment unit when the antenna device corresponds to 1500 MHz.

FIG. 13 is a diagram illustrating the connection state of the first frequency characteristic adjustment unit and the second frequency characteristic adjustment unit when the antenna device corresponds to 1700 MHz, 2000 MHz, or 2600 MHz.

FIG. 14(a) is a circuit diagram illustrating a first example of a resonance circuit, and FIG. 14 (b) is a circuit diagram illustrating a second example of a resonance circuit.

FIG. 15 is a block diagram illustrating the functional configuration of a wireless communication terminal according to a third embodiment.

### DESCRIPTION OF EMBODIMENTS

Hereinafter, embodiments of the present invention will be described with reference to the accompanying drawings. Also, in all of the drawings, the same components are attached with the same reference numerals and the description thereof is not repeated.

### First Embodiment

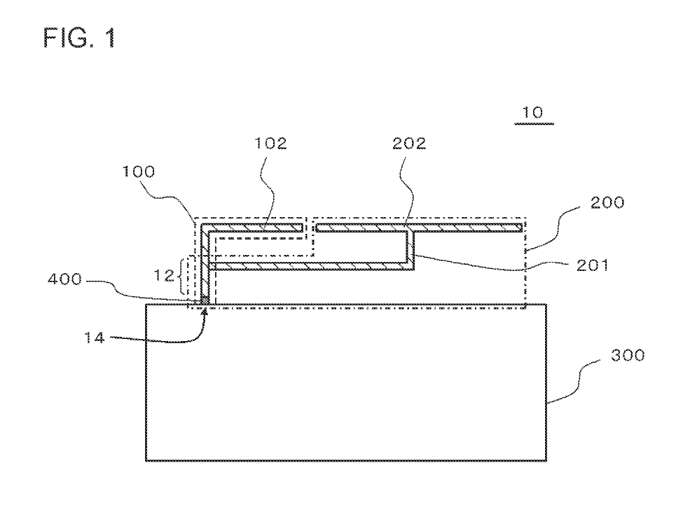

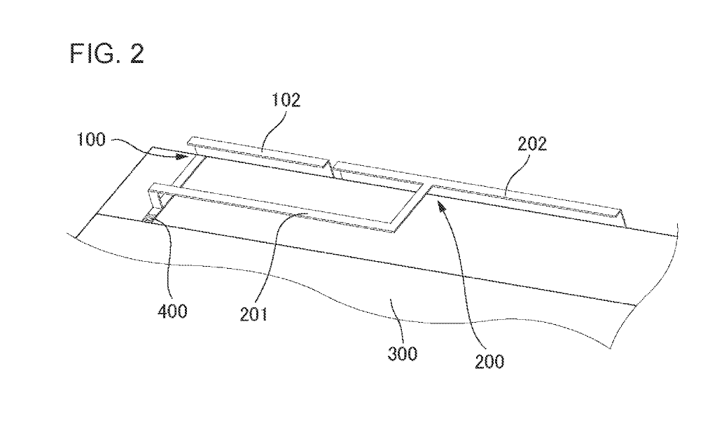

FIG. 1 is a planer view illustrating the configuration of an antenna device 10 according to a first embodiment. FIG. 2 is a perspective view illustrating the antenna device 10 shown in FIG. 1. The antenna device 10 includes a first antenna pattern 100, a second antenna pattern 200, and a frequency characteristic adjustment unit 400. The first antenna pattern 100 includes a feeding point 14. The second antenna pattern 200 is fed from the feeding point 14 similarly to the first antenna pattern 100. The frequency characteristic adjustment unit 400 is connected to the feeding point 14. The frequency characteristic adjustment unit 400 changes the frequency characteristic of at least one of the first antenna pattern 100 and the second antenna pattern 200.

In the embodiment, since the antenna device 10 includes the first antenna pattern 100 and the second antenna pattern 200, the antenna device 10 can cope with multiple bands. In addition, the first antenna pattern 100 and the second antenna pattern 200 include a common feeding point 14. Therefore, it is possible to prevent the antenna device 10 from being enlarged. Hereinafter, description will be performed in detail.

In the embodiment, the first antenna pattern 100 and the second antenna pattern 200 correspond to frequency bands which are different from each other. For example, the first antenna pattern 100 corresponds to frequency bands of 1500 MHz, 1700 MHz, and 2000 MHz, and the second antenna pattern 200 corresponds to frequency bands of 700 MHz, 800 MHz, and 2600 MHz. However, the frequency bands corresponding to each of the antenna patterns are not limited thereto. Further, both the first antenna pattern 100 and the second antenna pattern 200 are connected to a conductive pattern 300 through the frequency characteristic adjustment unit 400. The conductive pattern 300 is grounded.

The first antenna pattern 100 is an inverted L-type antenna. More specifically, the first antenna pattern 100 includes one end which is connected to the feeding point 14 through the frequency characteristic adjustment unit 400, and the other end which is open. More specifically, the first antenna pattern 100 extends from the feeding point 14 toward a first direction (upper direction in the drawing) and a tip section 102 thereof is bent at a right angle.

The second antenna pattern 200 is a T-type antenna, and includes a part which is shared by the first antenna pattern 100. More specifically, the first antenna pattern 100 and the second antenna pattern 200 include a common pattern 12 corresponding to a predetermined portion from the frequency characteristic adjustment unit 400. The second antenna pattern 200 includes an intermediate section 201 and a tip section 202 in addition to the common pattern 12. The intermediate section 201 includes one end which is connected to an end section of the common pattern 12 on a side opposite to the frequency characteristic adjustment unit 400. The intermediate section 201 extends from the common pattern 12 in parallel to the tip section 102 of the first antenna pattern 100, and then is bent at a right angle such that the intermediate section 201 extends in the same direction as the common pattern 12. The tip section 202 includes a linear pattern which is parallel to the tip section 102, and includes an intermediate section which is connected to the other end of the intermediate section 201. An open end on one side of the tip section 202 faces an open end of the tip section 102.

Meanwhile, as shown in FIG. 2, the common pattern 12 and the intermediate section 201 of the second antenna pattern 200 are formed in different layers. In addition, the tip section 102 of the first antenna pattern 100 and the tip section 202 of the second antenna pattern 200 include a cross section which has an inverted L shape, and portions, which correspond to the base of the L shape, are formed in the same layer as the intermediate section 201. Meanwhile, portions of the tip sections 102 and 202, which correspond to the top of the L shape, are formed in the same layer as the common pattern 12.

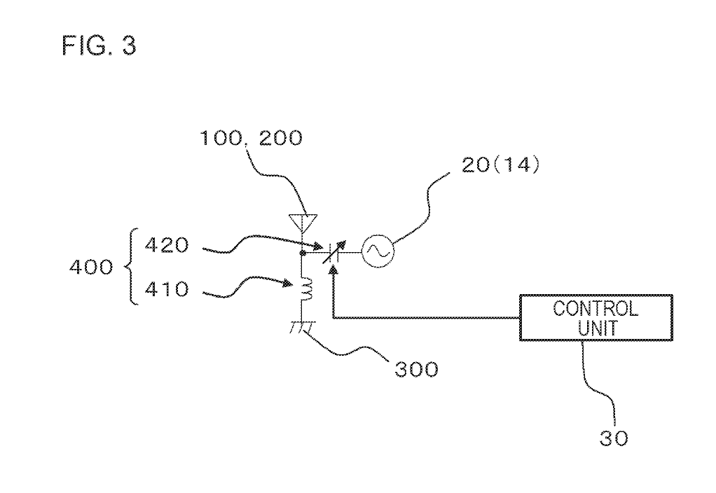

FIG. 3 is a circuit diagram illustrating the frequency characteristic adjustment unit 400. The frequency characteristic adjustment unit 400 includes an inductor 410 and a variable capacity element 420. The inductor 410 includes one end which is connected to the conductive pattern 300, and the other end which is connected to the first antenna pattern 100 and the second antenna pattern 200. The variable capacity element 420 includes one end which is connected to an oscillation signal generation unit 20 through the feeding point 14, and the other end which is connected between the inductor 410 and the first antenna pattern 100. The capacity of the variable capacity element 420 is controlled by a control unit 30. The control unit 30 controls the capacity of the variable capacity element 420 according to the frequency of a signal which is generated by the oscillation signal generation unit 20.

Subsequently, an action and an advantage of the embodiment will be described. According to the embodiment, the first antenna pattern 100 and the second antenna pattern 200 include the common feeding point 14. Therefore, it is possible to suppress the antenna device 10 from being enlarged.

In addition, since the first antenna pattern 100 and the second antenna pattern 200 are provided, it is possible to cope with the multiple bands. In particular, if the antenna device 10 is caused to cope with a frequency band of 800 MHz, 1500 MHz easily becomes the anti-resonance band of the antenna device 10. In contrast, in the embodiment, it is possible to separate 1500 MHz from an anti-resonance band of 800 MHz by respectively adjusting the length of the tip section 102, and the length of a portion of the tip section 202, which is positioned on a side of the tip section 102 from the connection point with the intermediate section 201.

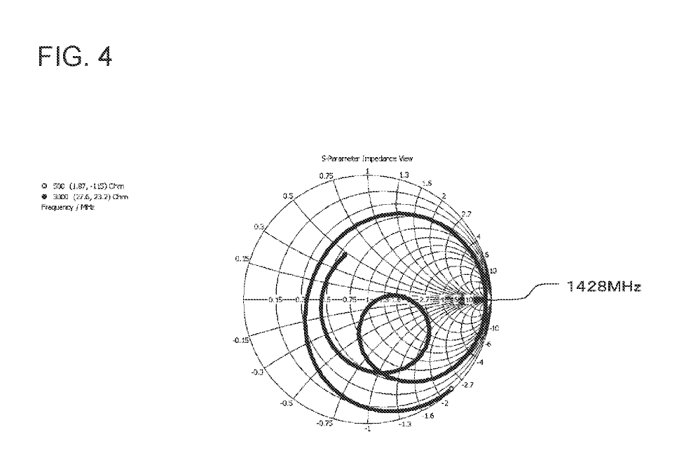

FIG. 4 is a Smith chart illustrating an antenna device according to a comparison example. The antenna device which is shown in the drawing copes with 800 MHz, 1700 MHz, 2000 MHz, and 2600 MHz. The anti-resonance frequency of the antenna device is 1428 MHz. Therefore, the performance of the antenna device at a frequency band of 1500 MHz is not sufficient.

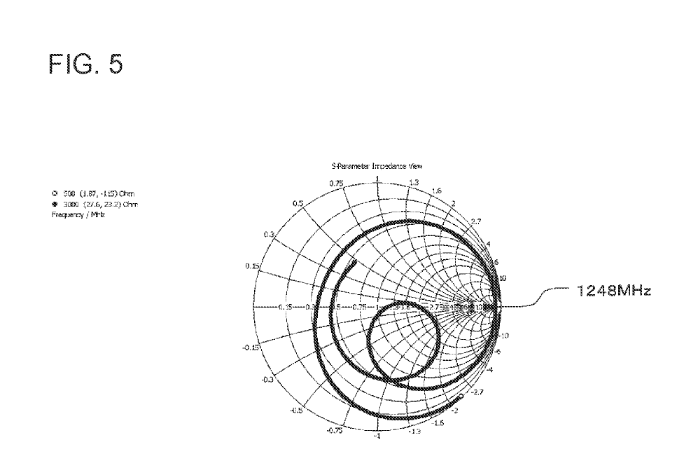

FIG. 5 is a Smith chart illustrating the antenna device 10. The length of the tip section 102 of the first antenna pattern 100 and the length of the portion of the tip section 202 of the second antenna pattern 200, which is positioned on the side of the tip section 102 from the connection point with the intermediate section 201, are respectively adjusted. Therefore, the anti-resonance frequency of the antenna device 10 is 1248 MHz. As a result, the antenna device 10 has sufficient performance even at a frequency band of 1500 MHz.

### Second Embodiment

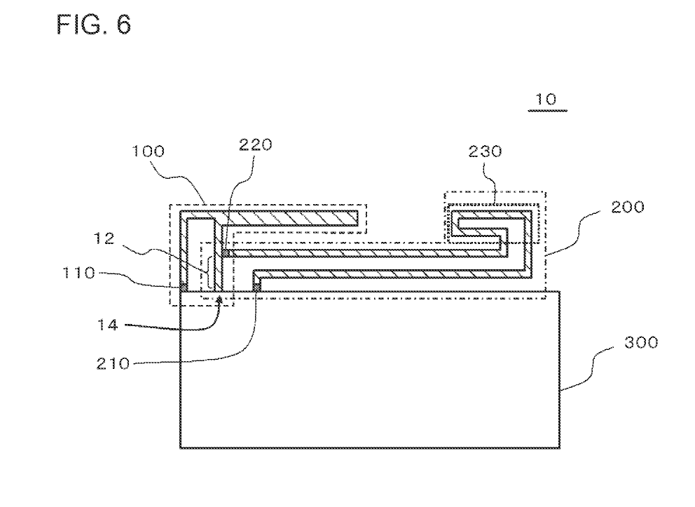

FIG. 6 is a diagram illustrating the configuration of an antenna device 10 according to a second embodiment. The antenna device 10 according to the embodiment includes the same configuration as the antenna device 10 according to the first embodiment except the following points.

First, a first antenna pattern 100 includes a first frequency characteristic adjustment unit 110, and a second antenna pattern 200 includes a second frequency characteristic adjustment unit 210. In the embodiment, the first antenna pattern 100 and the second antenna pattern 200 also include the common feeding point 14. Therefore, it is possible to suppress the antenna device 10 from being enlarged. Hereinafter, description will be performed in detail.

Both the first antenna pattern 100 and the second antenna pattern 200 include a short-circuit point with regard to the conductive pattern 300. Further, the first frequency characteristic adjustment unit 110 is provided at the short-circuit point of the first antenna pattern 100, and the second frequency characteristic adjustment unit 210 is provided at the short-circuit point of the second antenna pattern 200. Both the first frequency characteristic adjustment unit 110 and the second frequency characteristic adjustment unit 210 are controlled by the control unit 30 shown in FIG. 3.

In the embodiment, the first antenna pattern 100 is an inverted F-type antenna. In addition, the second antenna pattern 200 is a folded antenna. Further, a resonance circuit 220 is provided at a connection point between the second antenna pattern 200 and the common pattern 12. The resonance circuit 220 is set such that the impedance of the second antenna pattern 200 is large in a frequency band in which the first antenna pattern 100 performs communication.

In addition, the second antenna pattern 200 extends from the resonance circuit 220 in a direction away from the first antenna pattern 100, and then is bent by 180° in a direction approaching the first antenna pattern 100 (first bending portion). Thereafter, the second antenna pattern 200 is bent by 180° again, extends in the direction away from the first antenna pattern 100, is further bent by 180° (second bending portion), and extends in the direction approaching the first antenna pattern 100. It is possible for the second antenna pattern 200 to cope with a frequency band of 2600 MHz by adjusting the length of a portion (folding portion 230) from the first bending portion to the second bending portion.

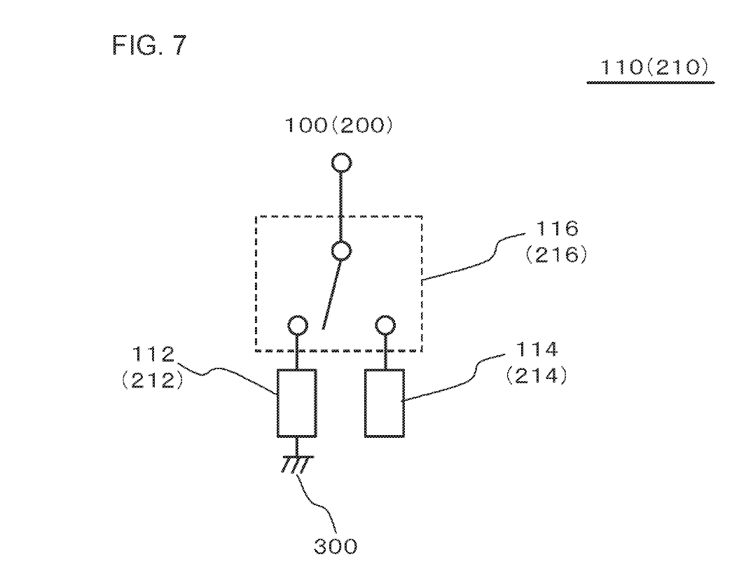

FIG. 7 is a diagram illustrating the configuration of a first frequency characteristic adjustment unit 110. Meanwhile, the second frequency characteristic adjustment unit 210 also includes the same configuration as the first frequency characteristic adjustment unit 110. The first frequency characteristic adjustment unit 110 (second frequency characteristic adjustment unit 210) includes a first circuit 112 (second circuit 212), a third circuit 114 (fourth circuit 214), and a switch 116 (switch 216). The first circuit 112 includes one end which is connected to the switch 116, and the other end which is connected to the conductive pattern 300. The third circuit 114 includes one end which is connected to the switch 116. The switch 116 connects the first antenna pattern 100 to one of the first circuit 112 and the third circuit 114. The switch 116 (216) is controlled by the control unit 30 (shown in FIG. 3).

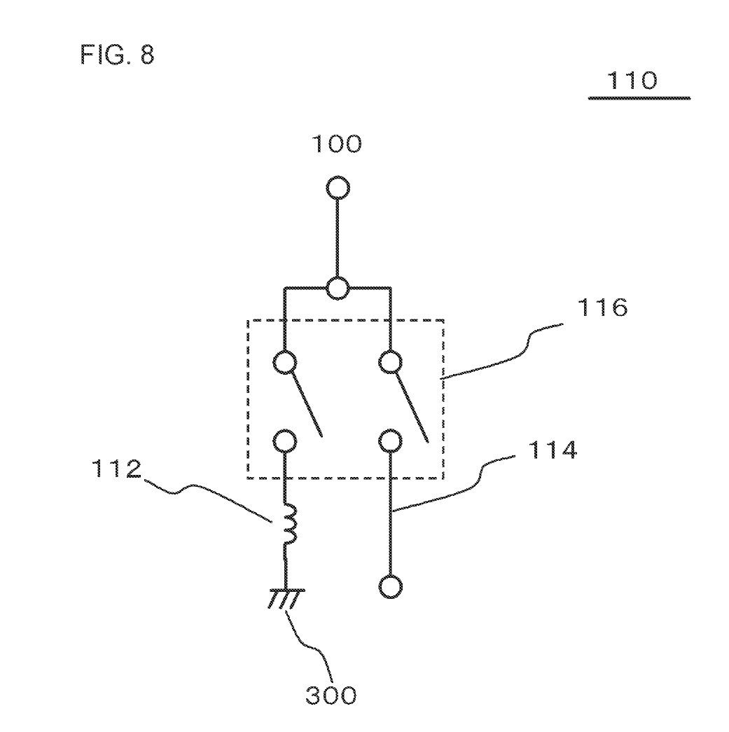

FIG. 8 is a diagram illustrating an example of the first circuit 112 and the third circuit 114 in detail. In the example shown in the drawing, the first circuit 112 includes an inductor (first element), and the third circuit 114 includes an open end.

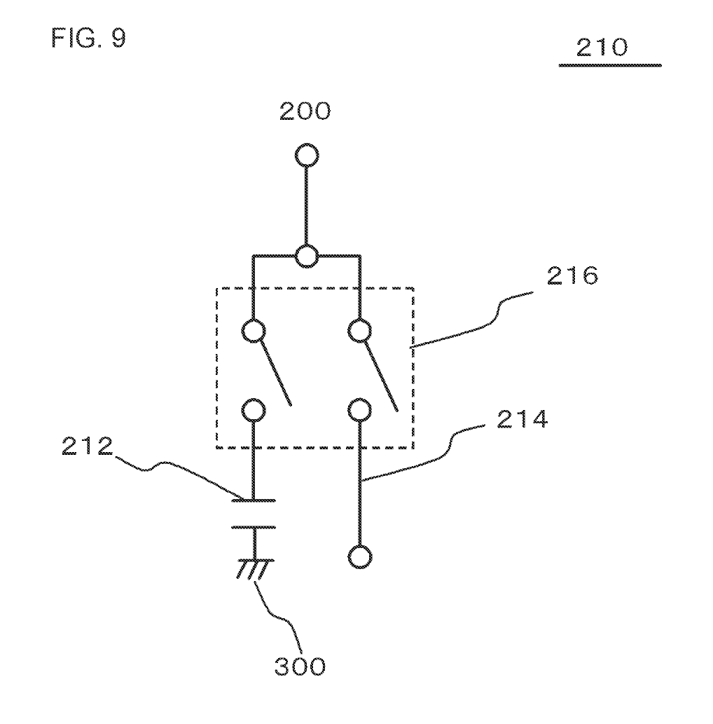

FIG. 9 is a diagram illustrating an example of the second circuit 212 and the fourth circuit 214 in detail. In the example shown in the drawing, the second circuit 212 is a capacitor (second element), and the fourth circuit 214 has an open end.

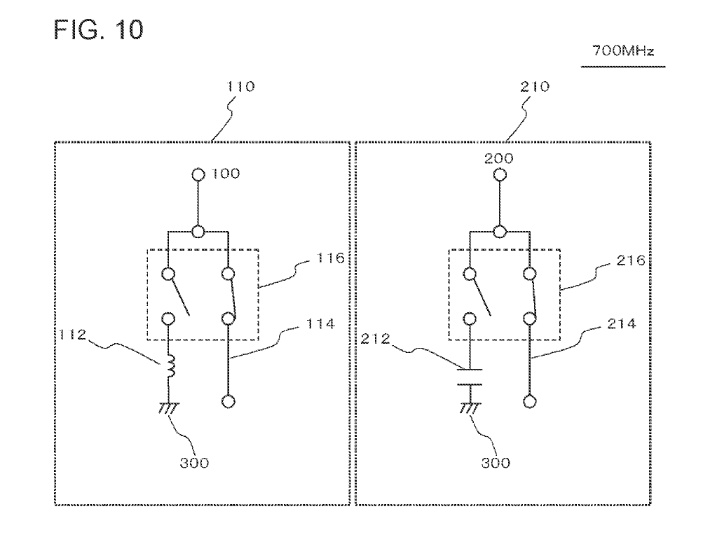

FIG. 10 is a diagram illustrating the connection state of the first frequency characteristic adjustment unit 110 and the second frequency characteristic adjustment unit 210 when the antenna device 10 copes with 700 MHz. In the example shown in the drawing, the first antenna pattern 100 is connected to the third circuit 114 (open end). In addition, the second antenna pattern 200 is also connected to the fourth circuit 214 (open end).

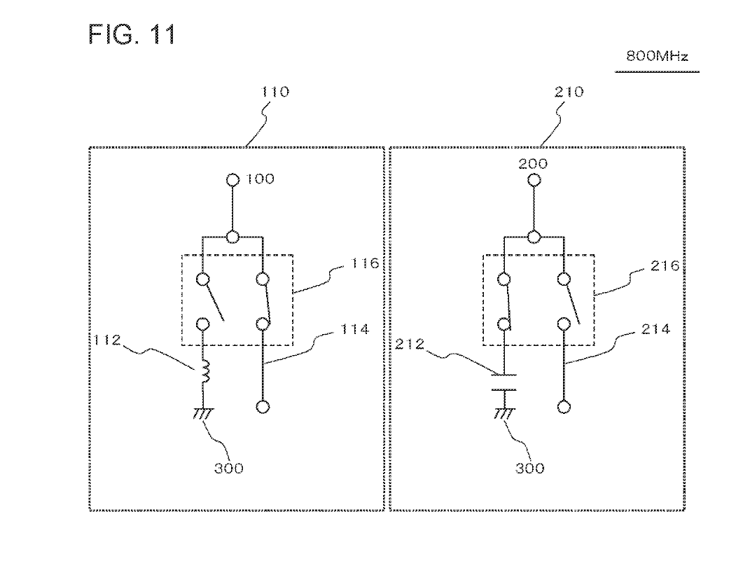

FIG. 11 is a diagram illustrating the connection state of the first frequency characteristic adjustment unit 110 and the second frequency characteristic adjustment unit 210 when the antenna device 10 copes with 800 MHz. In the example shown in the drawing, the first antenna pattern 100 is connected to the third circuit 114 (open end). In addition, the second antenna pattern 200 is connected to the second circuit 212 (capacitor).

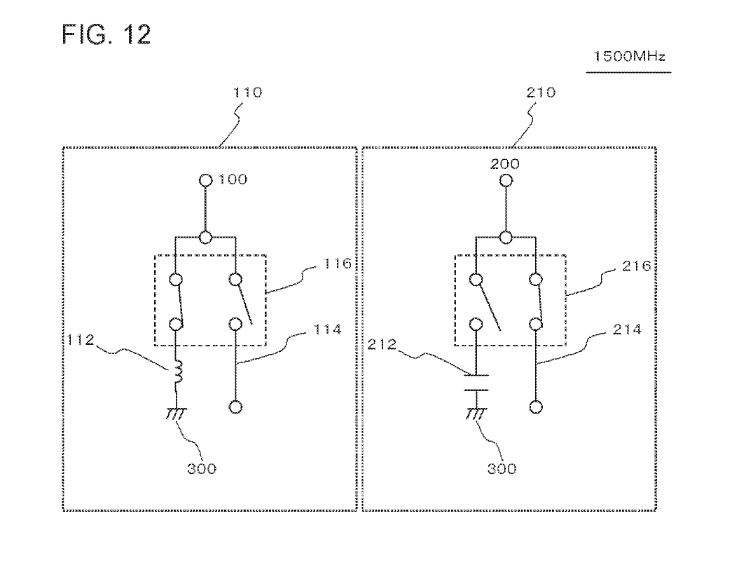

FIG. 12 is a diagram illustrating the connection state of the first frequency characteristic adjustment unit 110 and the second frequency characteristic adjustment unit 210 when the antenna device 10 copes with 1500 MHz. In the example shown in the drawing, the first antenna pattern 100 is connected to the first circuit 112 (inductor). In addition, the second antenna pattern 200 is connected to the fourth circuit 214 (open end).

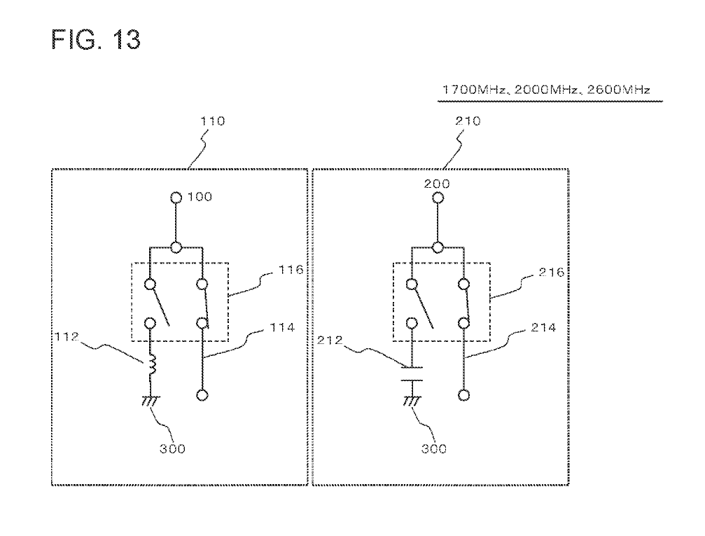

FIG. 13 is a diagram illustrating the connection state of the first frequency characteristic adjustment unit 110 and the second frequency characteristic adjustment unit 210 when the antenna device 10 copes with 1700 MHz, 2000 MHz, or 2600 MHz. In the example shown in the drawing, the first antenna pattern 100 is connected to the third circuit 114 (open end). In addition, the second antenna pattern 200 is also connected to the fourth circuit 214 (open end).

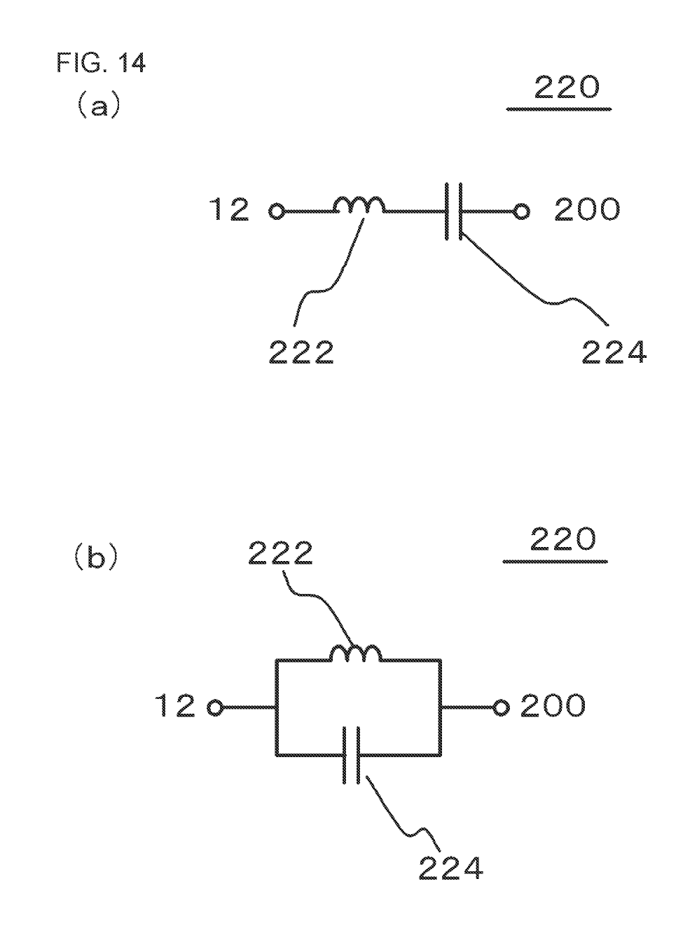

FIG. 14(a) is a circuit diagram illustrating a first example of the resonance circuit 220. In the example shown in the drawing, the resonance circuit 220 is acquired by connecting the inductor 222 to the capacity element 224 in series.

FIG. 14 (b) is a circuit diagram illustrating a second example of a resonance circuit 220. In the example shown in the drawing, the resonance circuit 220 is acquired by connecting the inductor 222 to the capacity element 224 in parallel.

In the embodiment, it is possible to acquire the same advantage as in the first embodiment. In addition, compared to the first embodiment, it is possible to further improve the characteristics of the antenna device 10 in each frequency band.

### Third Embodiment

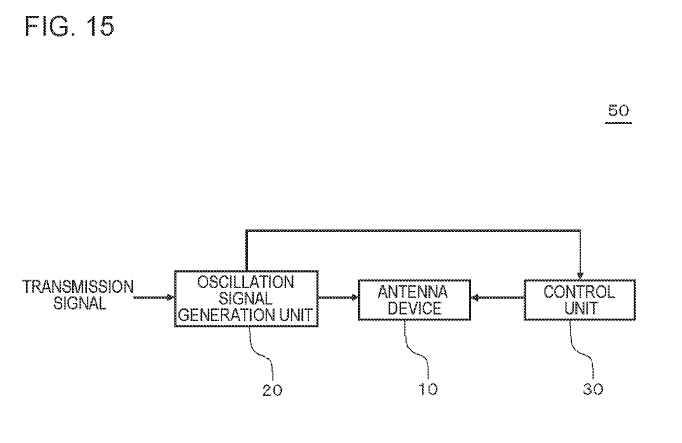

FIG. 15 is a block diagram illustrating the functional configuration of a wireless communication terminal 50 according to a third embodiment. A wireless communication terminal 50 includes an antenna device 10, an oscillation signal generation unit 20, and a control unit 30. The antenna device 10 is the same as shown in the first embodiment or the second embodiment. The oscillation signal generation unit 20 modulates a signal (data or audio) to be transmitted into a signal having a predetermined frequency, and outputs a resulting signal to the feeding point 14 of the antenna device 10. The control unit 30 receives a signal, which indicates the frequency of a modulation signal generated by the oscillation signal generation unit 20, from the oscillation signal generation unit 20, and controls the variable capacity element 420 of the antenna device 10, the first frequency characteristic adjustment unit 110, and the second frequency characteristic adjustment unit 210 based on the received signal.

According to the embodiment, it is possible to cause the wireless communication terminal 50 to cope with multiple bands. Therefore, the wireless communication terminal 50 can cope with roaming. In addition, since it is possible to make the antenna device 10 small, it is possible to make the wireless communication terminal 50 small.

Hereinabove, although the embodiments of the present invention have been described with reference to the accompanying drawings, the embodiments are examples of the present invention and various configurations other than the embodiments may be employed in addition thereto.

This application claims priority based on Japanese Unexamined Patent Publication NO. 2012-58957 applied on Mar. 15, 2012, and the entire contents thereof are incorporated herein.

1. An antenna device comprising:
a first antenna pattern that has a feeding point;
a second antenna pattern that is fed from a point which is the same as the feeding point; and
a frequency characteristic adjustment section that is connected to the feeding point, and that is configured to change a frequency characteristic of at least one of the first antenna pattern and the second antenna pattern.

2. The antenna device according to claim 1,
wherein both the first antenna pattern and the second antenna pattern include open ends, and the open ends face each other.

3. An antenna device comprising:
a first antenna pattern that has a feeding point;
a second antenna pattern that is fed from a point which is the same as the feeding point;
a first frequency characteristic adjustment section that is connected to the first antenna pattern, and that is configured to change a frequency characteristic of the first antenna pattern; and
a second frequency characteristic adjustment section that is connected to the second antenna pattern, and that is configured to change a frequency characteristic of the second antenna pattern.

4. The antenna device according to claim 3,
wherein the first antenna pattern includes a first short-circuit point that is short-circuited with regard to a conductive pattern,
wherein the second antenna pattern includes a second short-circuit point that is short-circuited with regard to the conductive pattern,
wherein the first frequency characteristic adjustment section is connected to the first short-circuit point, and
wherein the second frequency characteristic adjustment section is connected to the second short-circuit point.

5. The antenna device according to claim 4,
wherein the conductive pattern is grounded,
wherein the first frequency characteristic adjustment section includes:
a first element that includes one end which is connected to the conductive pattern; and
a first switch unit that selectively connects the first antenna pattern to one of another end of the first element and an open end, and
wherein the second frequency characteristic adjustment section includes:
a second element that includes one end which is connected to the conductive pattern; and
a second switch unit that selectively connects the second antenna pattern to one of another end of the second element and an open end.

6. The antenna device according to claim 3,
wherein the first antenna pattern is a folded antenna, and
wherein the second antenna pattern is an inverted F-type antenna.

7. The antenna device according to of claim 1,
wherein the first antenna pattern and the second antenna pattern include a common pattern corresponding to a portion having a predetermined length from the feeding point, and
wherein the first antenna pattern includes a resonance circuit in a portion which branches from the common pattern.

8. A wireless communication terminal comprising:
a first antenna pattern that includes a feeding point;
a second antenna pattern that is fed from a point which is the same as the feeding point;
a frequency characteristic adjustment section that is connected to the feeding point, and that is configured to change a frequency characteristic of at least one of the first antenna pattern and the second antenna pattern;
an oscillation signal generation unit that converts a signal, to be output to the outside, into an oscillation signal, which has a predetermined frequency, and supplies the oscillation signal to the feeding point; and
a control unit that controls the frequency characteristic adjustment section according to a value of the predetermined frequency.

9. A wireless communication terminal comprising:
a first antenna pattern that includes a feeding point;
a second antenna pattern that is fed from a point which is the same as the feeding point;
a first frequency characteristic adjustment section that is connected to the first antenna pattern, and that is configured to change a frequency characteristic of the first antenna pattern;
a second frequency characteristic adjustment section that is connected to the second antenna pattern, and that is configured to change a frequency characteristic of the second antenna pattern;
an oscillation signal generation unit that converts a signal, to be output to an outside, into an oscillation signal, which has a predetermined frequency, and supplies the oscillation signal to the feeding point; and
a control unit that controls at least one of the first frequency characteristic adjustment section and the second frequency characteristic adjustment section according to a value of the predetermined frequency.
